(19) United States
(12) Patent Application Publication
(10) Pub. No.: US 2023/0214412 A1
(43) Pub. Date: Jul. 6, 2023

(54) SEMANTIC SEARCH ENGINE

(71) Applicant: UNIVERSITY OF EXETER, Exeter, Devon (GB)

(72) Inventor: William Michael Short, Lympstone (GB)

(21) Appl. No.: 18/150,492

(22) Filed: Jan. 5, 2023

Related U.S. Application Data
(60) Provisional application No. 63/296,917, filed on Jan. 6, 2022.

(51) Int. Cl. G06F 16/33; G06F 16/31; G06F 16/387; G06F 16/338

(52) U.S. Cl. CPC G06F 16/3344; G06F 16/31; G06F 16/338; G06F 16/387

(57) ABSTRACT

The disclosure provides a method for generating an index file of a semantic search engine, and a method for generating a response to a user text query using the index file of the semantic search engine. The disclosure enables semantic searching of text documents or text data items to be performed.

### FIELD

The present techniques generally relate to a method and apparatus for implementing a semantic search engine. In particular, the present techniques provide a method for generating an index file of a semantic search engine, and a method for generating a response to a user text query using the index file of the semantic search engine.

### BACKGROUND

Currently available tools for searching text permit users to find words or phrases by several means, such as word-form queries, wildcard queries, and, in some limited cases, lemma queries. For all these types of searching, the basic querying mechanism is literal string matching. However, these types of search do not help to identify concepts within and across different text items. When identifying concepts, the specific words are often less important than what the words represent. As such, since the current text searching tools focus on identifying specific keywords or phrases, they are not suitable for identifying different words or phrases that convey the same meaning or for matching text items based on their lexical or semantic relationships to other words Moreover, existing text searching tools that do enable some form of concept-based searching tend to be limited to a single type of relationship, what is called “semantic similarity”.

The applicant has therefore identified the need for improved techniques for searching text.

### SUMMARY

In a first approach of the present techniques, there is provided a computer-implemented method for generating an index file for searching a text-based database of a concept-based (semantic) search engine, the method comprising: receiving an unstructured text data item; analysing, using an artificial intelligence module, the received unstructured text data item to determine semantic information encoded by at least one portion of text within the text data item; associating, using a lexical-conceptual database, an identifier to each portion of text for which semantic information is determined; and storing the determined semantic information as an entry in the index file, in association with information identifying the received text data item and the associated identifier.

The present techniques are advantageous because they provide a way of searching a corpus of textual data /text data items that uses concepts and conceptual relationships rather than keyword searching. That is, the present techniques use a lexical-conceptual knowledge base to enable the querying of the corpus of textual data using concepts and relations between concepts instead of literal or fuzzy string matching. (Here, the term “fuzzy string matching” refers to lemma-based matching. For example, the search term “walk” would also lead to results mentioning “walks”, “walked”, “walking”, and so on).

The term “index file” used herein has its ordinary meaning, i.e. a computer file with an index that allows easy random access to any text data item given a file key. In this case, the file key may be a concept rather than a keyword.

The term “text-based database” used herein is a database (or corpus) comprising a plurality of text data items. The text-based database may be specifically populated with text data items for particular use cases or customer types. For example, the database may comprise medical documents, medical journal articles, medical records, and so on, for use by doctors or other clinicians. Similarly, the database may comprise legal documents for use by lawyers or legal professionals. In other examples, the text-based database may be a news article database, a job advertisement database, a scholarly/academic literature database, a cultural archive, or a database of product descriptions on e-commerce websites, and so on. It will be understood these are non-limiting, illustrative examples of text-based databases. In some cases, the text data items within the text-based database may already be annotated with semantic information.

The term “unstructured text data item” used herein is used to mean that the text data item does not have a particular structure or does not need to be in a particular format. In other words, the unstructured text data item is raw text data and is not in any kind of tabular or structured format, and is not already accompanied by semantic data or other metadata. The unstructured text data item may be any data item comprising text, such as, but not limited to: a book, a newspaper, a newspaper article, a scientific or academic journal article, a historical document, or medical, legal, or technical documentation. The unstructured text data item may be a whole piece of text, such as a whole journal article, or may be a portion of a whole piece of text, such as a paragraph, a section or a sentence. It will be understood that these are merely illustrative example types of unstructured text data items, and are non-limiting.

The term “at least one portion of text within the text data item” used herein is used to mean a segment of the whole text data item. The portion of text may be, for example, a word, a phrase, multiple words, a sentence, multiple sentences, a paragraph or multiple paragraphs.

Analysing the received unstructured text data item may comprise: identifying a portion of text in the unstructured text data item; determining, using the lexical-conceptual database, at least one concept for the portion of text. In some lexical-conceptual databases, the concept is also known as a “synset”. A synset is defined as a group of data elements that are considered semantically equivalent for the purposes of information retrieval. In other words, the synset describes the concept denoted by the portion of text. Depending on the size of the portion of text, more than one concept may be determined for the portion of text. For example, for a single word, a single concept or multiple concepts may be determined, as some words can have multiple meanings. In another example, for a sentence or phrase or idiom, a single concept may be determined.

Associating a unique identifier may comprise: assigning an identifier associated with each determined concept to the portion of text, wherein each concept is associated with a unique identifier.

Analysing the received text data item may further comprise: determining, using the lexical-conceptual database, a semantic field for the portion of text, the semantic field indicating a set of words related in meaning; and assigning an identifier associated with the determined semantic field to the portion of text as part of the semantic information encoded by the portion of text. In some lexical-conceptual databases, the semantic field is referred to as a “semfield”. The semfield is a large-scale collection of concepts (or synsets). For example, the term “agriculture” may be a semfield which contains a large number of related concepts.

The lexical-conceptual database may be WordNet (George A. Miller (1995). WordNet: A Lexical Database for English. Communications of the ACM Vol. 38, No. 11: 39-41. Christiane Fellbaum (1998, ed.) WordNet: An Electronic Lexical Database. Cambridge, MA: MIT Press. Princeton University “About WordNet.” WordNet. Princeton University. 2010.) It will be understood that this is a non-limiting example lexical-conceptual database.

The at least one portion of text may be any one of: a single word, a set of words, at least two consecutive words, a phrase, a sentence, and a paragraph.

Storing the determined semantic information as an entry in the index file may comprise storing the semantic information without storing the received text data item. Instead, storing the determined semantic information as an entry in the index file may comprise storing metadata indicating a location, within the received text data item, of the portion of text for which sematic information is determined. That is, the location of the portion of text may be stored to reduce the amount of data that is stored within the index file, which may also speed-up the time to provide results in response to a search query.

Alternatively, storing the determined semantic information as an entry in the index file may comprise storing the semantic information with the received text data item.

In a second approach of the present techniques, there is provided a computer-implemented method for generating a response to a query using a (semantic) concept-based search engine, the method comprising: receiving, via a user interface, a user text query; searching an index file of the concept-based search engine to identify at least one entry that matches the user text query; and outputting, via the user interface, information, from a text-based database of the concept-based search engine, identifying at least one text data item associated with an entry in the index file, when the searching identifies at least one entry in the index file that matches the user text query.

The user text query may be structured or in a particular format suitable for use by the concept-based search engine. For example, the format of the user text query may be such that the concept is clearly identifiable by the concept-based search engine. For example, the user text query may be “[%p|government]”, which would be understood by the concept-based search engine to mean that the search engine should search for any concept (synset) that is a PART OF the concept denoted by the word “government”. In other words, the search engine should search for any concept that is related to the word “government” by a PART relation. This may produce results including the words “legislature”, “administration”, “courts”, and so on. Thus, the user text query may comprise at least one word representing a concept and a relationship or relationship type for the concept. The relationship type may be any suitable relationship type, such as, but not limited to: a substance holonym, similar to, domain of usage, a substance meronym, a part meronym, and a member meronym. It will be understood this is a non-limiting list of example relationship types.

The method may further comprise analysing the received user text query to determine semantic information encoded by the at least one word representing a concept. That is, the method may analyse the at least one word so that the correct concept is searched for by the search engine.

Analysing the received user text query may comprise: determining, using a lexical-conceptual database, a unique identifier associated with the at least one word representing a concept. That is, each concept may be associated with a unique identifier in the lexical-conceptual database, which makes searching for the concept more efficient.

Searching the index file may comprise searching the index file using the unique identifier associated with the at least one word representing a concept.

The lexical-conceptual database may be WordNet. It will be understood that this is a non-limiting example lexical-conceptual database.

The at least one portion of text may be any one of: a single word, a set of words, at least two consecutive words, a phrase, a sentence, and a paragraph.

In a third approach of the present techniques, there is provided a system for generating a response to a query using a (semantic) concept-based search engine, the system comprising: at least one electronic apparatus comprising: a user interface, and at least one processor coupled to memory, arranged to: receive, via the user interface, a user text query; and a server comprising: at least one text-based database; an index file of the concept-based search engine comprising a plurality of entries, each entry comprising semantic information associated with information identifying at least one text data item in the text-based database that encodes the semantic information; and at least one processor coupled to memory and arranged to: receive the user text query from the electronic apparatus; search the index file to identify at least one entry that matches the user text query; and output, via the user interface of the electronic apparatus, information from the text-based database identifying at least one text data item associated with an entry in the index file, when the searching identifies at least one entry in the index file that matches the user text query.

The features described above with respect to the second approach apply equally to the third approach and, for the sake of conciseness are not repeated.

As mentioned above, the text-based database is a database (or corpus) comprising a plurality of text data items. The text-based database may be specifically populated with text data items for particular use cases or customer types. For example, the database may comprise medical documents, medical journal articles, medical records, and so on, for use by doctors or other clinicians. Similarly, the database may comprise legal documents for use by lawyers or legal professionals. In other examples, the text-based database may be a news article database, a job advertisement database, a scholarly/academic literature database, a cultural archive, or a database of product descriptions on e-commerce websites, and so on. It will be understood these are non-limiting, illustrative examples of text-based databases. In some cases, the text data items within the text-based database may already be annotated with semantic information. Thus, the text-based database of the server may be a medical database, legal database, or financial database. The server may comprise multiple text-based databases. It will be understood that these are merely illustrative example databases and are not limiting.

In a related approach of the present techniques, there is provided a non-transitory data carrier carrying processor control code to implement any of the methods, processes and techniques described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages. Code components may be embodied as procedures, methods or the like, and may comprise subcomponents which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

### BRIEF DESCRIPTION OF THE DRAWINGS

Implementations of the present techniques will now be described, by way of example only, with reference to the accompanying drawings, in which:

FIG. 1 shows a flowchart of example steps to generate an index file of a semantic search engine;

FIG. 2 is a diagram illustrating synsets and semantic fields contained in a lexical-conceptual database for an input word;

FIG. 3 is a diagram illustrating an example indexing schema for a sample unstructured text data item;

FIG. 4 shows a schematic diagram of an indexing pipeline that may be used to analyse text and generate at least one entry in the index;

FIG. 5 shows a flowchart of example steps to generate a response to a query using an index file of a semantic search engine;

FIG. 6 is a schematic diagram illustrating how the semantic search engine is used to generate an index file and generate a response to a query;

FIG. 7 is a block diagram of an apparatus for generating a response to a query using an index file of a semantic search engine;

FIG. 8 shows an example user interface for receiving a user text query; and

FIG. 9 shows an example user interface for providing a response to a user text query.

### DETAILED DESCRIPTION OF THE DRAWINGS

Broadly speaking, embodiments of the present techniques provide a method for generating an index file of a semantic search engine, and a method for generating a response to a user text query using the index file of the semantic search engine. This advantageously enables concept-based searching of text documents or text data items to be performed.

The present techniques provide a semantic search engine, which permits users to search textual data on the basis of concepts and their relations, rather than only by literal keywords.

As mentioned above, currently available tools for searching texts permit users to find words or phrases by several means: word-form queries, wildcard queries, lemma queries, part-of-speech queries, or syntax-based queries. Some currently available tools for searching texts also permit users to find synonyms of the query word. However, it may be useful in some information retrieval tasks to search on the basis of relationships between concepts, when the specific words that occur may be less important than the relationship between concepts that these words represent.

For example, to find all possible occurrences of words that denote parts of the body in an item of text, a traditional keyword-based search engine requires many distinct queries to be performed, for each individual body part; or the specification of a complex compound query that tries to capture all possibilities. The typical form of such a query would be (‘leg’ OR ‘arm’ OR ‘chest’ OR ‘shoulder’...), but to be anything close to comprehensive would also need to include alternative morphological forms, leading to increasingly complex query strings such as ((‘leg’ OR ‘legs’) OR (‘arm’ OR ‘arms’) OR ‘chest’ OR (‘shoulder’ OR ‘shoulders’)...). Specifying queries in this manner is highly time-consuming and error-prone, particularly as the burden is thus placed on the user to determine any potentially relevant word, along with its possible forms. The query would soon become unwieldy: ((‘leg’ OR ‘legs’) OR (‘arm’ OR ‘arms’) OR (‘chest’ OR ‘torso’ OR ‘breast’ OR ‘thorax’ OR ‘sternum’)) OR (‘shoulder’ OR ‘shoulders’)...) A search engine that can instead abstract away from the words themselves to the level of concepts and conceptual relationships makes this task more efficient, by contrast, by permitting users to perform a single query specifying the equivalent of “parts of the body.”

The present techniques take this basic functionality – the ability to search text by the concepts (not only the words) and conceptual relationships represented in it – and apply it to datasets of all kinds.

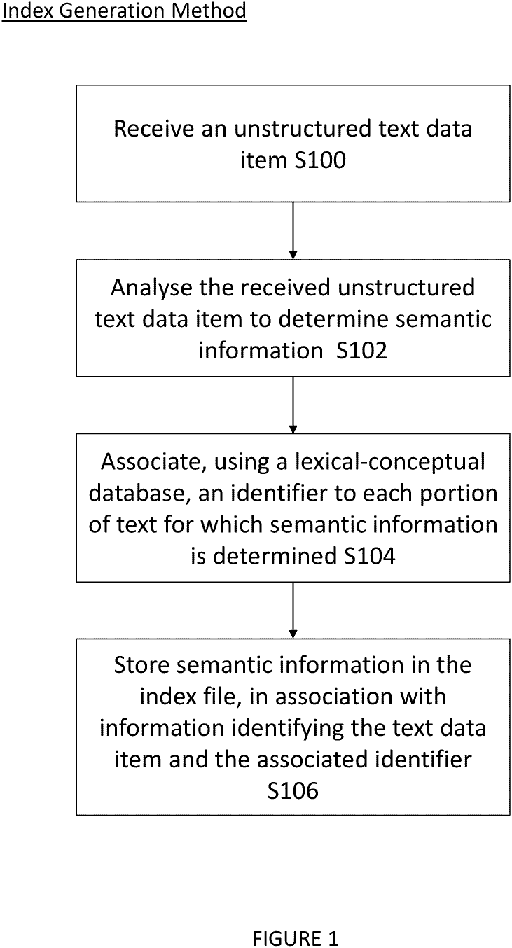

FIG. 1 shows a flowchart of example steps to generate an index file for searching a text-based database of a semantic/concept-based search engine. Index files or index structures used for searching records (text data items) in text-based database is technically advantageous because they control the way the search engine performs the search operation. Specifically, the index file enables the searching of the text-based database to be significantly faster and more computationally-efficient, as the index file can be searched first instead of the many documents/data items within the database.

The method begins by receiving an unstructured text data item (step S100) to be analysed by the concept-based search engine. As noted above, the term “unstructured text data item” means that the text data item is not in a particular format and is not linked to semantic or concept data already. The purpose of the analysis is to generate entries in the index file that represent concepts contained within the text data item. The text data item may be anything, from a newspaper article to a classical text to a historical document. In some cases, a single index file may be generated based on different text data items. Alternatively, it may be more efficient to generate an index file per customer (who may be, for example, an individual, a specific research department, or a group of people who would be searching the same documents, such as medical doctor). In this case, each index file is tailored to a particular customer, which may make the semantic searching more efficient. The unstructured text data item may be a whole piece of text, such as a whole journal article, or may be a portion of a whole piece of text, such as a paragraph, a section or a sentence. It will be understood that these are merely illustrative example types of unstructured text data items, and are non-limiting.

The method comprises analysing, using an artificial intelligence module, the received unstructured text data item to determine semantic information encoded by at least one portion of text within the text data item (step S102).

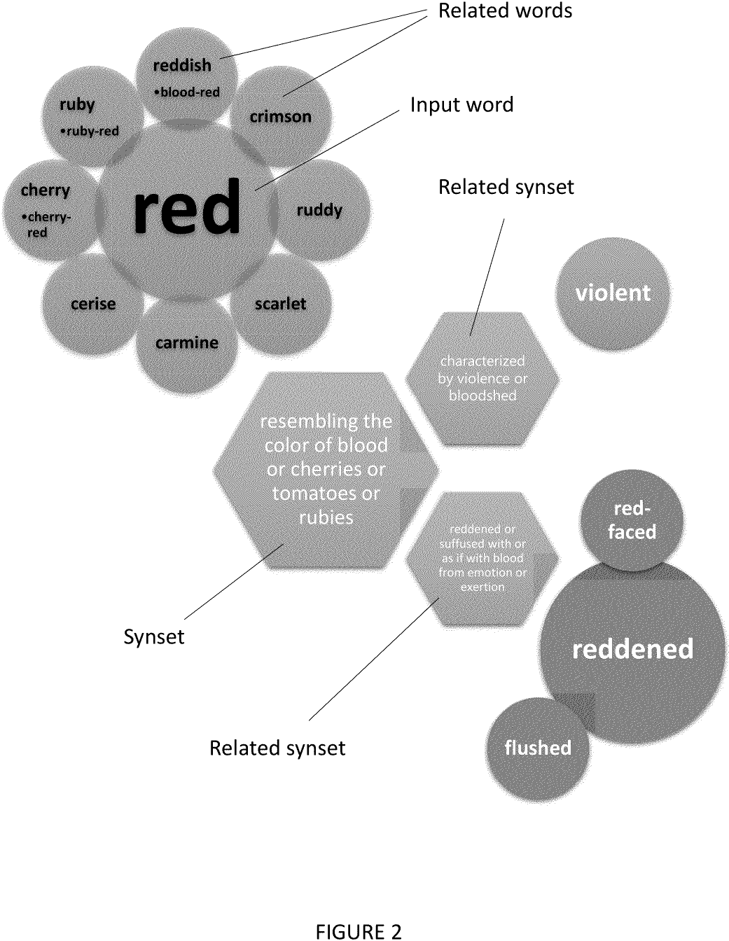

Turning briefly to FIG. 2, this is a diagram illustrating synsets (concepts) and semantic fields contained within a particular lexical-conceptual database for an input word, in this case the WordNet database. The Princeton WordNet (George A. Miller (1995). WordNet: A Lexical Database for English. Communications of the ACM Vol. 38, No. 11: 39-41. Christiane Fellbaum (1998, ed.) WordNet: An Electronic Lexical Database. Cambridge, MA: MIT Press. Princeton University “About WordNet.” WordNet. Princeton University. 2010.) is a lexical-conceptual database of English. In WordNet, the senses of English words (lemmas) are defined in terms of synsets, which are definitions paired with unique identification numbers. Words and synsets can also participate in various kinds of relations (antonymy, synonymy, superordinate and subordinate relations, etc.) and are organised into larger conceptual fields (called semantic fields or semfields).

For example, as shown in FIG. 2, when an input word “red” is input into WordNet, a number of related words or synonyms are identified which link to the concept that “red” is a colour. Thus, the related words (synonyms) also represent colours that are similar to “red”, such as “scarlet” and “ruby”.

These synonyms, which all represent the same concept, are grouped by WordNet into an unordered set, called a synset, which also includes a definition. For example, the synset may indicate that the words resemble the colour the blood or cherries or tomatoes or rubies. The synset may itself be linked to other synsets that represent closely related definitions. For example, as shown in FIG. 2, a related synset may indicate that the words are linked to “violence or bloodshed”. Each related synset may define the senses of other words, literally or figuratively. It can be seen therefore, that the input word “red” is not just linked to the concept of a colour, but also to the word “violent” and to the word “flushed”. This linking of words to senses, and of senses to senses, creates a rich and dense network model of the conceptual and lexical relationships that characterise the English language.

Returning to FIG. 1, the step S102 of analysing the received text data item may comprise: identifying a portion of text in the unstructured text data item; determining, using the lexical-conceptual database, at least one concept (or synset) for the portion of text. Depending on the text, more than one concept may be determined for the portion of text. For example, for a single word, a single concept or multiple concepts may be determined, as some words can have multiple meanings. In another example, for a sentence or phrase or idiom, a single concept may be determined.

The step S102 of analysing the received text data item may further comprise: determining, using the lexical-conceptual database, a semantic field for the portion of text, the semantic field indicating a set of words related in meaning; and assigning an identifier associated with the determined semantic field to the portion of text as part of the semantic information encoded by the portion of text. In some lexical-conceptual databases, the semantic field is referred to as a “semfield”. The semfield is a large-scale collection of concepts (or synsets) For example, the term “agriculture” may be a semfield which contains a large number of related concepts.

The at least one portion of text may be any one of: a single word, a set of words, at least two consecutive words, a phrase, a sentence, and a paragraph. For example, the at least one portion of text may be the words:
“The red badge of courage”, or
The words “The”, “red”, “badge of”, and/or “courage”, or
Just the word “red”.

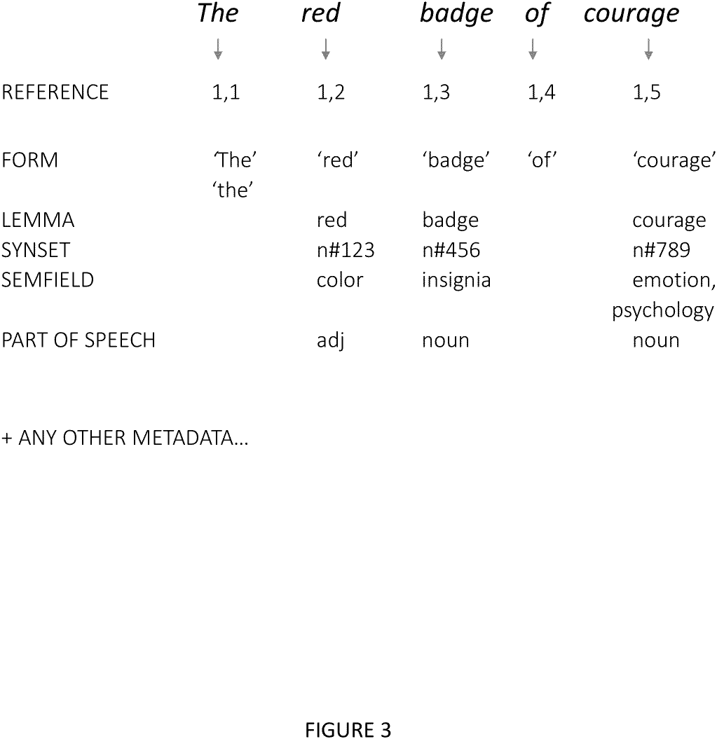

Turning briefly to FIG. 3, this is a diagram illustrating an example indexing schema. It can be seen that an input text data item contains a number of (five) words, which have been analysed. Words which do not represent a concept, such as “the” and “of”, may be ignored when creating an index and when performing a concept-based search, because these words are not searchable using concept-based queries. A unique identifier for the concept associated with each remaining word (“red”, “badge” and “courage”) is determined and assigned to each word (portion of text) as well as a semantic field. For example, the unique identifier for the concept of the colour red may be n#123. The unique identifier is defined within the lexical-conceptual database being used (e.g. WordNet). This is why a user can find “red badge of courage” by searching for “[crimson] [emblem] of [bravery]”. In the index, those words have been associated with concept-identifiers. As both red and crimson are linked to the same identifier n#123 in the WordNet, when a user queries “[crimson]”, this identifier is matched in the index, independent of what word in the text originally determined the association.

Thus, returning to FIG. 1, the method comprises associating, using a lexical-conceptual database, an identifier to each portion of text for which semantic (concept) information is determined (step S104). The identifier associated with each portion of text may be the or each unique identifier associated with the portion of text. In other words, if each portion of text is associated with a single concept, the identifier may be the unique identifier for that concept within the lexical-conceptual database. Similarly, if each portion of text is associated with multiple concepts, it may be associated with multiple unique identifiers (taken from the lexical-conceptual database).

As shown in FIG. 1, the method comprises storing the determined semantic information as an entry in the index file, in association with information identifying the received text data item and the associated identifier (step S104).

In some cases, storing the determined semantic information as an entry in the index file may comprise storing the semantic information without storing the received text data item. That is, the semantic search engine does not store the text data items that are used to generate the index - once the entry or entries in the index have been generated using a particular text data item, the text data item is discarded. Instead, storing the determined semantic information as an entry in the index file may comprise storing metadata indicating a location, within the received text data item, of the portion of text for which sematic information is determined. That is, the location of the portion of text may be stored to reduce the amount of data that is stored within the index file, which may also speed-up the time to provide results in response to a search query.

Alternatively, storing the determined semantic information as an entry in the index file may comprise storing the semantic information with the received text data item.

In either case, the received text data item may be added to the text-based database, so that it can be searched/queried in the future. That is, the process to generate the index file may also generate/populate the text-based database of the concept-based search engine. As described above, different index files may be generated for different use cases/applications/groups of users. In the same way, different text-based databases may also be generated, which may make retrieving results in response to user queries faster compared to retrieving results from one single database.

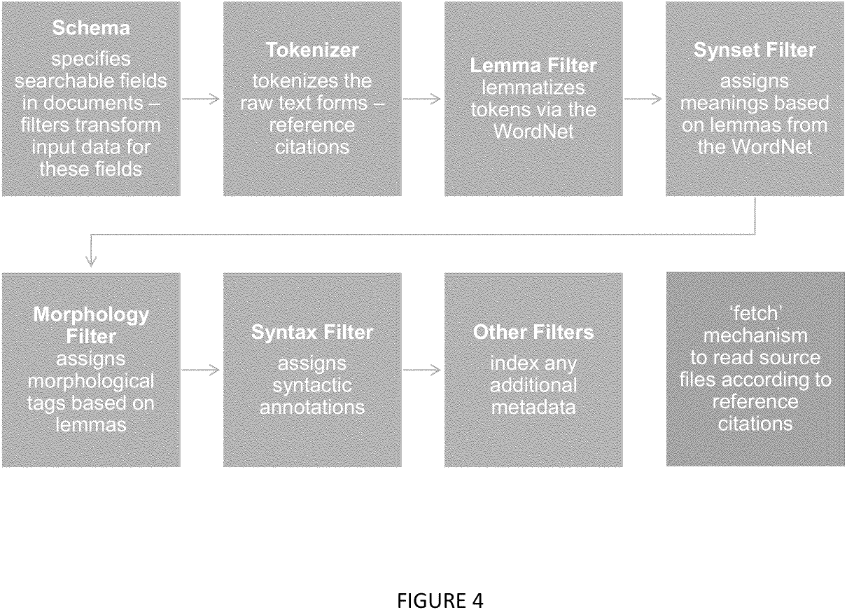

FIG. 4 shows a schematic diagram of an indexing pipeline that may be used to analyse text and generate at least one entry in the index. As already mentioned, before the semantic/concept-based search engine can be used, the index file needs to be generated. As shown in FIG. 4, an ingestion module is built/provided for each corpus, so that text data items for each corpus can be indexed. The ingestion module may be tailored for each corpus of data because the format of the data items, the text that is to be indexed, and the eventual output, may differ between corpuses. For each corpus, there may be a specific index schema that specifies the metadata to be stored for each indexed text data item and the searchable fields within the indexed text data item.

A pre-processing step may perform any text processing or cleaning of data before a text data item from a corpus is indexed. The pre-processing step may involve collecting metadata and text data that will be passed to the tokenisation and filtering pipeline. The metadata and text data that is collected may differ by document type (e.g. raw/unstructured text data, structured text data, XML, PDF, and so on).

The tokenisation and filtering pipeline may feed data into indexable fields that constitute queryable units. For example, the indexable fields may be FORM (raw word forms), LEMMA, SYNSET, SEMFIELD, MORPHOSYNTAX, and so on. Each pipeline may be tailored to the structure of the incoming text data items. Sense disambiguation may take place as part of this pipeline, as well as discourse topic modelling. This corpus-specific pipeline may also include a text ‘fetch’ functionality that resolves any matches from the indexes to the original text via indexed referencing information.

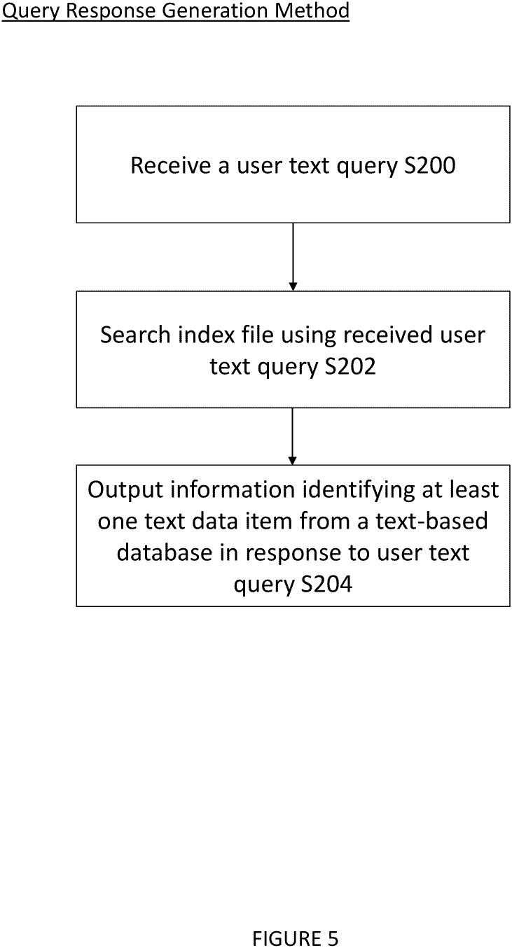

FIG. 5 shows a flowchart of example steps to generate a response to a query using an index file of a semantic/concept-based search engine. The method comprises receiving, via a user interface, a user text query (step S200). The user text query may be a single word or multiple words. The user text query may be structured or in a particular format suitable for use by the concept-based search engine. For example, the format of the user text query may be such that the concept is clearly identifiable by the concept-based search engine. For example, the user text query may be “[%p|government]”, which would be understood by the concept-based search engine to mean that the search engine should search for any concept (synset) that is a PART OF the concept denoted by the word “government”. In other words, the search engine should search for any concept that is related to the word “government” by a PART relation. This may produce results including the words “legislature”, “administration”, “courts”, and so on. Thus, the user text query may comprise at least one word representing a concept and a relationship or relationship type for the concept. The relationship type may be any suitable relationship type, such as, but not limited to: a substance holonym, similar to, domain of usage, a substance meronym, a part meronym, and a member meronym. It will be understood this is a non-limiting list of example relationship types.

The method comprises searching an index file of the concept-based search engine to identify at least one entry that matches the user text query (step S202).

The method may further comprise analysing the received user text query to determine semantic information encoded by the at least one word representing a concept. That is, the method may analyse the at least one word so that the correct concept is searched for by the search engine.

Analysing the received user text query may comprise: determining, using a lexical-conceptual database, a unique identifier associated with the at least one word representing a concept. That is, each concept may be associated with a unique identifier in the lexical-conceptual database, which makes searching for the concept more efficient.

Searching the index file may comprise searching the index file using the unique identifier associated with the at least one word representing a concept.

The method comprises outputting, via the user interface, information, from a text-based database of the concept-based search engine, identifying at least one text data item associated with an entry in the index file, when the searching identifies at least one entry in the index file that matches the user text query (step S204).

Identifying a portion of text in the received user text query may comprise identifying a plurality of portions of text in the received user text query, and further comprise determining semantic information for each portion of text. In this case, searching the index file may comprise searching the index file to identify at least one entry that matches the semantic information encoded by the plurality of portions of text. That is, the search may identify any entry in the index file which matches the semantic information of all portions of text.

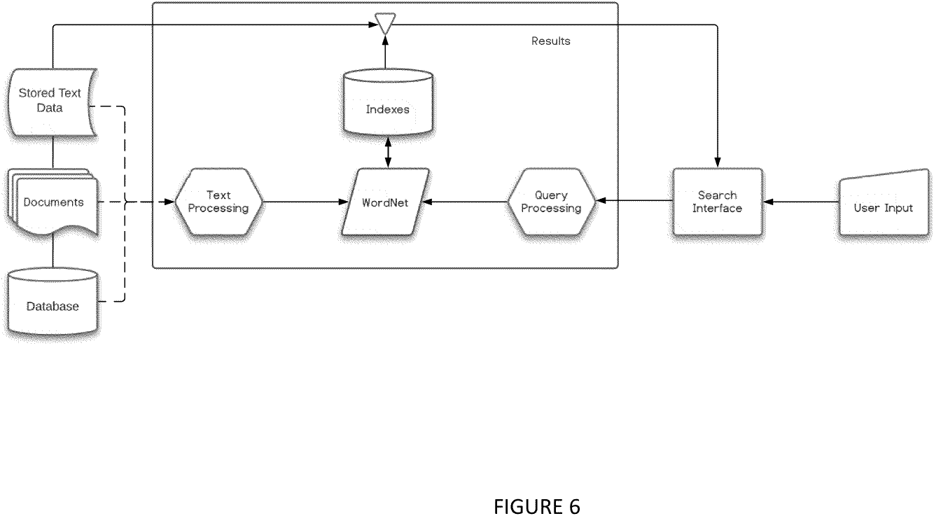

FIG. 6 is a schematic diagram illustrating how the semantic search engine is used to generate an index file and generate a response to a query. The present techniques comprise a text processing module, which ingests a customer’s text-based data (of whatever form or structure). The text is lemmatized, analysed morphologically, and tagged with semantic (synset, semfield) information from a lexical-conceptual database (as explained above with reference to FIGS. 2 to 4). The ‘gold standard’ case for accuracy may be a customer text database that is already pre-annotated with semantic information - otherwise, this information is determined on the basis of lemmatization. Reference information to the original text document is indexed so that results can be displayed.

With the indexes in place, the customer inputs a query via the search interface. The query is parsed by the present techniques and converted into constructs of the lexical-conceptual database, which are then matched to the document indexes. Finally, the referencing information from the indexes is used to retrieve the original document for display as results to the user via the search interface.

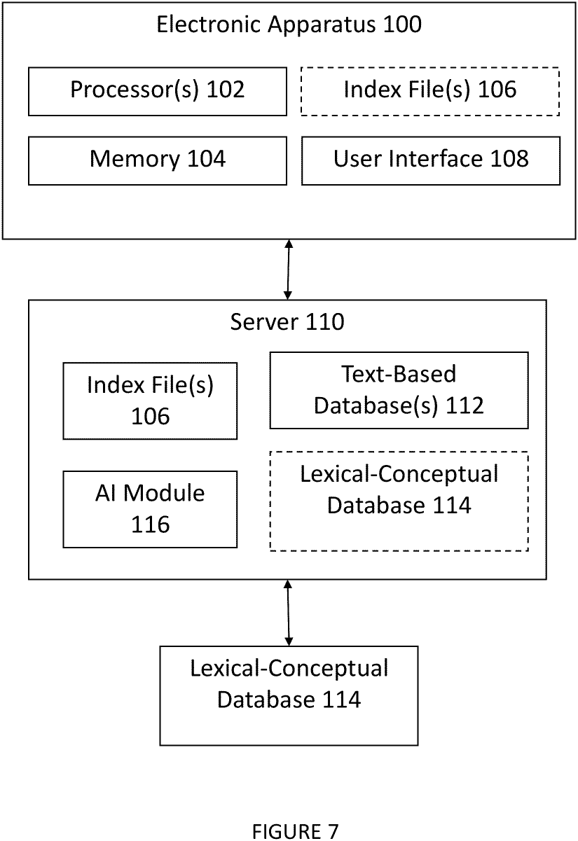

FIG. 7 is a block diagram of a system for generating a response to a query using a semantic/concept-based search engine, and for generating an index for the semantic/concept-based search engine.

The system comprises at least one electronic apparatus 100. The electronic apparatus 100 may be a computer, a smartphone, tablet, a server, or any suitable computing device. FIG. 7 shows a single electronic apparatus 100 for the sake of simplicity, but it will be understood that the system may comprise a plurality of electronic apparatuses, from tens to millions.

The electronic apparatus 100 comprises at least one processor 102 coupled to memory 104. The at least one processor 102 may comprise one or more of: a microprocessor, a microcontroller, and an integrated circuit. The memory 104 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The electronic apparatus 100 comprises a user interface 108 through which users may submit text data items as part of the index generation process (described above with respect to FIG. 1) and/or user text queries as part of the semantic search process (described above with respect to FIG. 5).

In some cases, the electronic apparatus 100 may comprise at least one index file 106, the or each index file comprising a plurality of entries, each entry comprising semantic information associated with information identifying a text data item that encodes the semantic information. The or each index file 106 is generated as described above with reference to FIG. 1. Alternatively, the index file(s) 106 may be located on a central server rather than on each electronic apparatus.

The system comprises at least one server 110. Multiple electronic apparatuses 100 may communicate with the or each server 110. The server 110 comprises at least one processor coupled to memory for implementing the functions of the server.

The server 110 comprises at least one text-based database 112. The or each text-based database 112 may be specifically populated with text data items for particular use cases or customer types. For example, one database may comprise medical documents, medical journal articles, medical records, and so on, for use by doctors or other clinicians. Similarly, another database may comprise legal documents for use by lawyers or legal professionals.

The server 110 comprises at least one index file 106 of the concept-based search engine, the or each index file 106 comprising a plurality of entries, each entry comprising semantic information associated with information identifying at least one text data item in the text-based database 112 that encodes the semantic information.

The at least one processor of the server 110 is arranged to: receive the user text query from the electronic apparatus 100; search the index file 106 to identify at least one entry that matches the user text query; and output, via the user interface of the electronic apparatus 100, information from the text-based database 112 identifying at least one text data item associated with an entry in the index file 106, when the searching identifies at least one entry in the index file that matches the user text query.

As noted above, the system of FIG. 7 may be used to implement the index generation process (described above with respect to FIG. 1) and/or to process user text queries as part of the semantic search process (described above with respect to FIG. 5). Thus, the process described above with reference to FIG. 1 may be implemented by the server 110, and the process described above with reference to FIG. 5 may be implemented by the server 110. User inputs (either text data items or text queries) may be received by the server 110 from the electronic apparatus 100 (via the user interface).

Thus, the server 110 may comprise an artificial intelligence, AI, module 116. The AI module 116 may be used to analyse the unstructured text data items received during the index file generation process, to determine semantic information encoded by at least one portion of text within the received text data items. The system comprises a lexical-conceptual database 114. The lexical-conceptual database 114 may be part of the server 110 or may be external to the server 110, in which case the server 110 may communicate with the lexical-conceptual database 114 as and when required. The AI module 116 may determine at least one concept for the portion of text using the lexical-conceptual database 114.

Thus, the present techniques use identifiers, such as WordNet identifiers, as a way to generate semantic descriptions for text data items, where the semantic descriptions are machine-readable and machine-actionable. Furthermore, the present techniques provide a way to process input queries that enable text data items to be searched in terms of these constructs.

The present techniques have a number of advantages which can be understood by comparison with existing approaches to text searching.

Some traditional keyword searching techniques match only the literal words provided by the user query (‘red’, ‘badge’, ‘courage’) within document text. In the best cases, users can search by lemmas, so that inflectional or part-of-speech variations are also found (‘badges’ as well as ‘badge’, ‘courageous’ as well as ‘courage’). Manually curated lists of alternate expressions (‘DUI’ = ‘DWI’) or of phrasal lexical items or idioms can improve results.

With the addition of machine learning, such keyword searches may utilize calculations of ‘semantic similarity’ to find words that appear in similar contexts (i.e., that behave functionally or ‘semantically’ in the same way in large datasets). Similarly, ontology-based search engines utilize domain-specific taxonomies (especially of named entities) to make answering queries more intelligent (e.g., NEW YORK CITY is a CITY in AMERICA; the MAYOR of NEW YORK CITY is BILL DE BLASIO).

Thus, the present techniques provide a semantic search engine technology, which differs from keyword search in that it takes advantage of a lexical-conceptual knowledge base to enable querying text by means of concepts and by relations between concepts - rather than only through literal or fuzzy string matching. (In this sense, ‘fuzzy’ matching refers to lemma-based matching, i.e. a query of ‘walk’ would also match ‘walks’, ‘walked’, ‘walking’, etc.). In some implementations, the present techniques may take advantage of the Princeton WordNet as a lexical and conceptual ontology, and its specialized query language exposes the data types and structures of the WordNet. Thus concepts are understood as the abstractions represented by WordNet synsets and semantic relations are understood as relations between synsets – of several types – encoded in the WordNet.

As a result of using a lexical-conceptual database, the query language of the present techniques exposes sophisticated and rich relational structures to search users. This differentiates the present techniques from other ‘semantic’ search tools which are based either on machine learning – limiting semantic relations to a single kind: synonymy – or on domain-specific ontologies - tending to capture only hierarchical (superordinate and subordinate taxonomic, i.e. ‘KIND OF’, relations). Synonymy or ‘semantic similarity’ relations are common and available in many search engines. For example, appending the tilde ‘~’ to any query string in Google will produce results that include synonyms or near synonyms of the query term.

Semantic queries that take advantage of the conceptual relations encoded in the lexical-conceptual database enable searches that retrieve information in novel and potentially highly efficient ways. For example, a user who wished to find all occurrences (within some set of documents) of any part of the body, would be compelled – when using a keyword search engine – to search for ‘arm’, ‘leg’, ‘shoulder’, ‘chest’, ‘neck’, and so on, individually for every part of the body. Alternatively, using Boolean query operators, the user could construct a complex compound query such as ‘arm OR leg OR shoulder OR chest... ‘. However this kind of compound query is highly dependent on the knowledge of the user (to recall the names of parts of the body) and very time consuming. It is also error prone in that correct Boolean query construction requires precise syntactic formulas (balanced parentheses etc.). Furthermore within the Boolean query each search term is again literally matched. Thus ‘arm OR leg OR shoulder’ would not necessarily capture occurrences of arms, legs, shoulders, compounding the requirements of the user to provide a comprehensive set of query terms. By contrast, the present techniques’ specialized query type can include PART-WHOLE relationships. Thus a single query such as: “[#p|body]” (read as: ‘part of the concept BODY’), will produce results that include any literal form of ‘arm’, ‘leg’ and so on. This is possible because the present techniques do not search for literal word forms, but for the concepts represented by word forms.

The ability to execute searches based on complex semantic relationships beyond synonymy and taxonomy (hypernym, hyponymy) potentially enables the present techniques –in certain cases – to have a technical effect, which consists of computational efficiency. The present techniques leads to an improvement in computational efficiency. Take the ‘parts of the body’ query again as an example. With a keyword based search system, the computational demands on the underlying hardware system can be stated in simple terms to be the number of queries required of a comprehensive search multiplied by the time required for each search. Say the total lexical domain of PARTS OF THE BODY is represented by the following terms:
arm, arms
leg, legs
head
shoulder, shoulders
neck
knee, knees
elbow, elbows
finger, fingers
   o thumb, thumbs
   o pointer finger, pointer fingers
   o pinkie, pinkies
foot, feet

If it is stipulated that, within a given set of queried documents, every search requires 3 seconds (for example), the total time to cover this domain would be 22 * 3 = 1 minute 6 seconds.

A compound Boolean query of the type ((arm OR arms) OR (head) OR (leg OR legs) OR (shoulder OR shoulders)) could reduce the search time and thus the computational demands by a certain amount, however keyword search engines handle such compound searches by aggregating results of discrete searches - as if a user had searched for each term individually, and then consolidated the results. Furthermore, whilst the computational time is reduced, the user’s time is vastly increased. If the user is considered as part of the distributed informational retrieval system, this means that overall search time for such a query can become prohibitive.

In contrast, the present techniques execute this kind of search as a single query, which resolves to a set of semantic identifiers, potentially vastly reducing computational demands on hardware systems.

Some example use cases of the present techniques are outlined below. Generally speaking, a user performs a search for some textual information when they do not know beforehand in what words that information is expressed in the target dataset.

“Bibliographic search.” A student is searching the Exeter University catalogue for a book whose title they cannot remember: was it The crimson emblem of bravery? Whilst any traditional keyword-based engine will fail to find the correct title – A red badge of courage (by Stephen Crane) – Epexegetical AI will do so, because it does not (only) search for keywords but for the concepts these words represent.

“News report search.” An investigative reporter is trying to find news reports in an online database about the American war in Iraq. Searching for ‘Iraq war’ will return only results in which those literal words appear; but relevant documents might also contain ‘Iraq conflict’, ‘warfare’, and so on. To gather more results, the search could be broadened to include concepts like ‘military engagement’, ‘military forces’. Epexegetical AI can return all results together based on conceptual relations.

“Medical abstract search.” A medical researcher is trying to find all articles that discuss rash symptoms of a certain illness. A traditional search engine will require discrete queries for ‘rash’, ‘skin rash’, ‘efflorescence’, ‘roseola’. Epexegetical AI will find results containing all these terms at once.

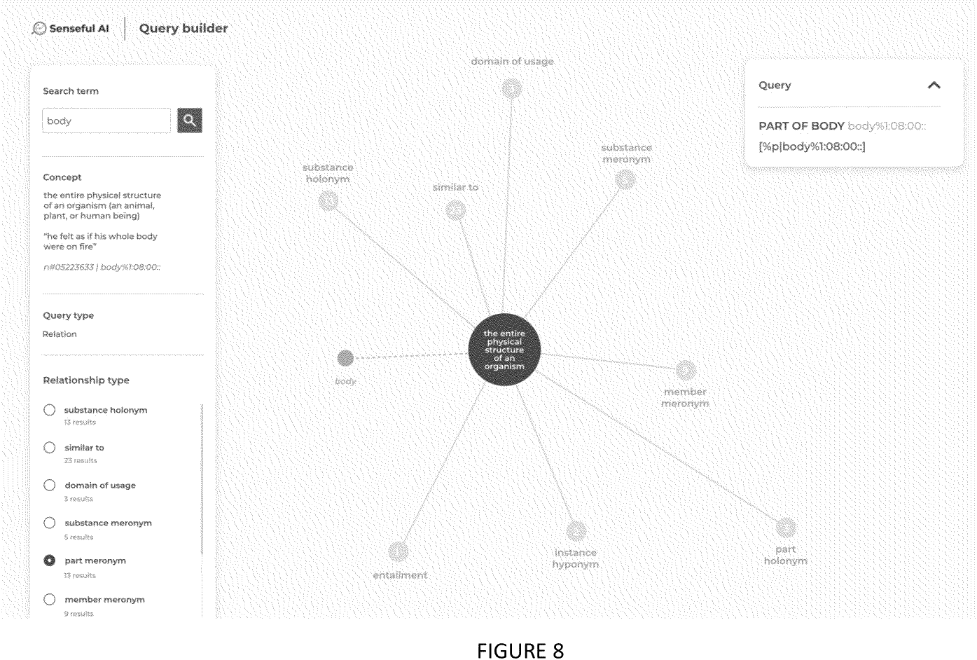

FIG. 8 shows an example user interface for receiving a user text query. A user may use the user interface on their electronic apparatus. The user interface may comprise a field into which a user may type their text query. In the example shown here, the user has entered the word “body” as their user text query. The user interface displays a concept associated with the input user text query. As mentioned above, the user text query may comprise at least one word representing a concept and a relationship or relationship type for the concept. In the example shown here, the user has specified the “part meronym” relationship type. This means that the user is effectively performing a search for “parts of the body”, rather than just “body” and without having to specify specific body parts. The user interface provides a visual representation of the user’s text query, which in this case is a graph showing the original concept and its links to other concepts via different relationship types. This visual representation helps reduce the time to perform complex searches and reduces the risk of error associated with keyword searching.

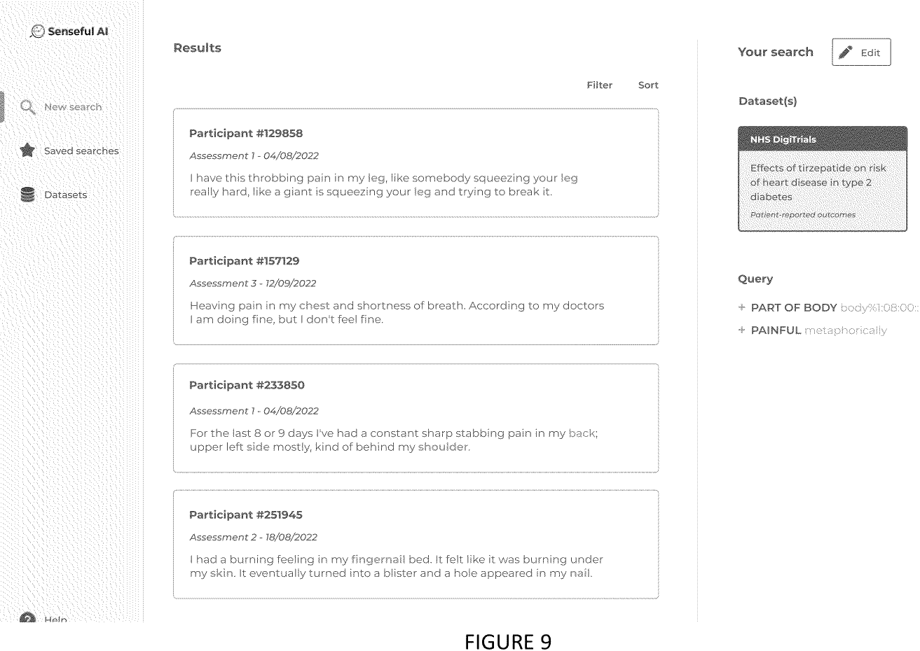

FIG. 9 shows an example user interface for providing a response to a user text query. It can be seen here that multiple results are provided based on the input user query shown in FIG. 8. Based on the input of “part of body”, the concept-based search engine has output results that include occurrences of parts of the body (e.g. arm, leg, shoulder, back, and so on), which quickly provides results without having to perform individual keyword searching for each body part.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A computer-implemented method for generating an index file for searching a text-based database of a concept-based search engine, the method comprising:
receiving an unstructured text data item;
analysing, using an artificial intelligence module, the received unstructured text data item to determine semantic information encoded by at least one portion of text within the unstructured text data item;
associating, using a lexical-conceptual database, an identifier to each portion of text for which semantic information is determined; and
storing the determined semantic information as an entry in the index file, in association with information identifying the received unstructured text data item and the associated identifier.

2. The method as claimed in claim 1, wherein analysing the received unstructured text data item includes:
identifying a portion of text in the unstructured text data item; and
determining, using the lexical-conceptual database, at least one concept for the portion of text.

3. The method as claimed in claim 2, wherein each concept is associated with a unique identifier.

4. The method as claimed in claim 2, wherein analysing the received unstructured text data item further includes:
determining, using the lexical-conceptual database, a semantic field for the portion of text, the semantic field indicating a set of words related in meaning; and
assigning the identifier associated with the determined semantic field to the portion of text as part of the semantic information encoded by the portion of text.

5. The method as claimed in claim 1, wherein the lexical-conceptual database includes English words grouped into synsets.

6. The method as claimed in claim 1, wherein the at least one portion of text is one of a single word, a set of words, at least two consecutive words, a phrase, a sentence, or a paragraph.

7. The method as claimed in claim 1, wherein storing the determined semantic information as an entry in the index file comprises storing the semantic information without storing the received unstructured text data item.

8. The method as claimed in claim 1, wherein storing the determined semantic information as an entry in the index file comprises storing metadata indicating a location within the received unstructured text data item of the portion of text for which sematic information is determined.

9. A computer-implemented method for generating a response to a query using a concept-based search engine, the method comprising:
receiving, via a user interface, a user text query;
searching an index file of the concept-based search engine to identify at least one entry that matches the user text query; and
outputting, via the user interface, information from a text-based database of the concept-based search engine identifying at least one text data item associated with an entry in the index file, when the searching identifies at least one entry in the index file that matches the user text query.

10. The method as claimed in claim 9, wherein the user text query comprises at least one word representing a concept, and a relationship for the concept.

11. The method as claimed in claim 10, further comprising analysing the received user text query to determine semantic information encoded by the at least one word representing a concept.

12. The method as claimed in claim 11, wherein the analysing comprises: determining, using a lexical-conceptual database, a unique identifier associated with the at least one word representing a concept.

13. The method as claimed in claim 12, wherein searching the index file comprises searching the index file using the unique identifier associated with the at least one word representing a concept.

14. The method as claimed in claim 9, wherein the at least one text data item is one of a single word, a set of words, at least two consecutive words, a phrase, a sentence, or a paragraph.

15. A system for generating a response to a query using a concept-based search engine, the system comprising:
at least one electronic apparatus, comprising:
a user interface, and
at least one processor coupled to memory, arranged to:
receive, via the user interface, a user text query; and
a server comprising:
at least one text-based database;
an index file of the concept-based search engine comprising a plurality of entries, each entry comprising semantic information associated with information identifying at least one text data item in the text-based database that encodes the semantic information; and
at least one processor coupled to memory and arranged to:
receive the user text query from the electronic apparatus;
search the index file to identify at least one entry that matches the user text query; and
output, via the user interface of the electronic apparatus, information from the text-based database identifying at least one text data item associated with an entry in the index file, when the searching identifies at least one entry in the index file that matches the user text query.

16. The system as claimed in claim 15, wherein the user text query comprises at least one word representing a concept, and a relationship for the concept.

17. The system as claimed in claim 16, wherein the at least one processor of the server is further arranged to analyse the received user text query to determine semantic information encoded by the at least one word representing a concept.

18. The system as claimed in claim 17, wherein analysing the received user text query further includes determining, using a lexical-conceptual database, a unique identifier associated with the at least one word representing a concept.

19. The system as claimed in claim 18, wherein searching the index file includes searching the index file using the unique identifier associated with the at least one word representing a concept.

20. The system as claimed in claim 15, wherein the text-based database is one of a medical database, a legal database, or a financial database.
